(19) United States
(12) Patent Application Publication
(10) Pub. No.: US 2012/0233077 A1
(43) Pub. Date: Sep. 13, 2012

(54) ELECTRIC CHARGING STATION RESERVATION SYSTEM AND METHOD

(75) Inventors: Edward D. Tate, JR., Grand Blanc, MI (US); Steven A. Tarnowsky, West Bloomfield, MI (US)

(73) Assignee: GM GLOBAL TECHNOLOGY OPERATIONS LLC, Detroit, MI (US)

(21) Appl. No.: 13/041,478

(22) Filed: Mar. 7, 2011

(51) Int. Cl. G06Q 20/00; G01C 21/00; G06Q 10/00

(52) U.S. Cl. 705/65; 705/5

(57) ABSTRACT

A method for reserving a vehicle charging station includes receiving a desired destination, and automatically verifying the availability of a designated station at an expected arrival time. The method further includes reserving the designated station when the designated station is available at the expected arrival time, and transmitting an electronic token to the client device. The token confirms the reservation and uniquely identifies the vehicle. A system for reserving the station includes a server in communication with the station, and with a client device configured for communicating a desired destination to the server. The server automatically verifies the availability of the designated charging station at an expected arrival time at the desired destination, reserves the designated station when it is available at the expected arrival time, and then generates and transmits the token to the client device.

### TECHNICAL FIELD

The present disclosure relates to a system and method for reserving an electric charging station of the type used to recharge a battery module of a vehicle having at least one electric vehicle operating mode.

### BACKGROUND

Battery electric vehicles (BEV), plug-in hybrid electric vehicles (PHEV), and extended-range electric vehicles (EREV) all use high-voltage rechargeable battery modules to power one or more electric traction motors. When an internal combustion engine is present in the powertrain, the battery module may be recharged during operation using fuel energy. The battery module may also be recharged during operation via regenerative braking energy. When the vehicle is idle, the battery module may be recharged using an off-board energy supply. For instance, when the vehicle is parked in a garage, the battery module may be recharged using either a standard 110V outlet or, for higher-speed charging, a 220V outlet. When away from home, recharging may be provided by an electric charging station.

### SUMMARY

A method is disclosed herein for reserving such an electric charging station. Public charging stations are part of the infrastructure necessary for electric vehicles (EVs) of any type. The availability of such public charging stations at a target destination, as well as the efficient utilization of such charging stations, are principal issues of concern for EV drivers. The present method addresses these concerns by allowing a driver to automatically reserve an electric charging station, and by ensuring the charging priority of the vehicle at the reserved charging station upon arrival.

In particular, a method for reserving an electric charging station includes receiving a desired destination from a client device, e.g., a navigation system or a smart phone, using a server, and automatically verifying the availability of the station at an expected arrival time at the desired destination. The method includes reserving the station when the station is available at the expected arrival time, and transmitting an electronic token to the client device. The electronic token confirms the reservation and uniquely identifies the vehicle.

A system for reserving an electric charging station for a vehicle includes a server in communication with the station and with a client device. The server includes tangible memory and an algorithm or instructions for executing the present method. The server receives a desired destination from the client device, and automatically verifies the availability of the station at an expected arrival time at the desired destination. The server reserves the station when it is available at the expected arrival time, and generates and transmits the electronic token to the client device.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a system for reserving an electric charging station for a vehicle having an electric-only (EV) operating mode; and

FIG. 2 is a flow chart describing an embodiment of the present method.

### DESCRIPTION

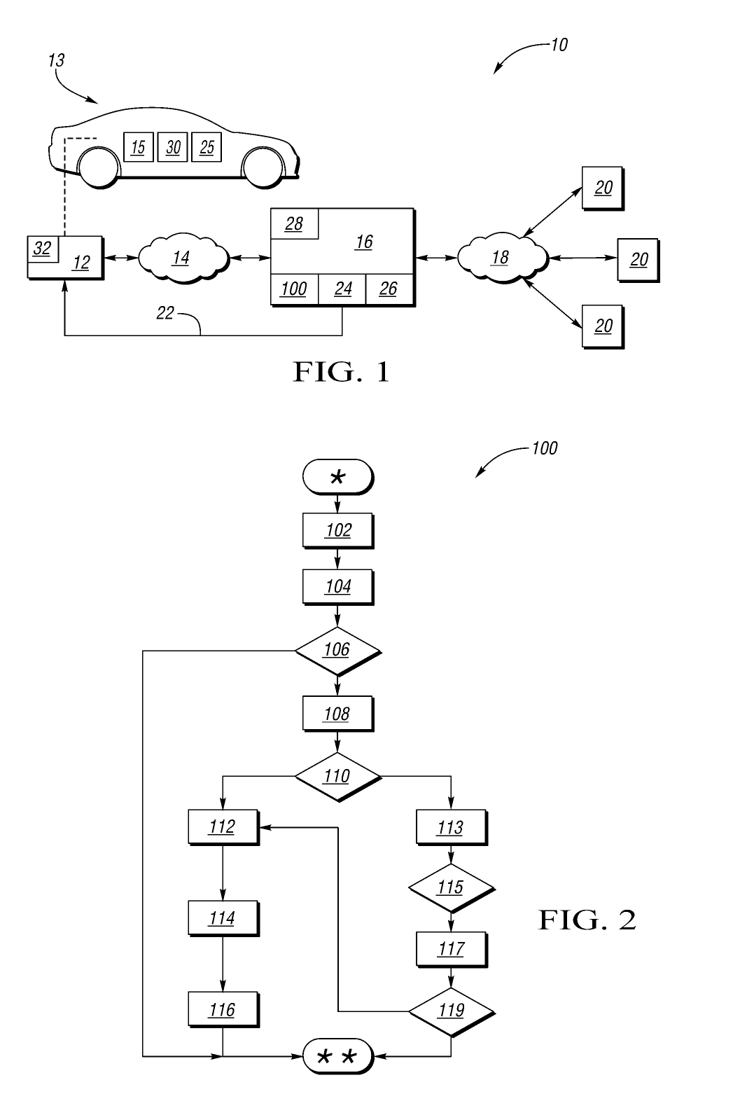

Referring to the drawings, wherein like reference numbers correspond to like or similar components throughout the several figures, a system 10 is shown in FIG. 1 for reserving one of a plurality of electric charging stations 20. The charging stations 20 may be any publicly or privately accessible charging device to which a driver of a vehicle 13 can connect for the purpose of recharging a battery module 15. For instance, the vehicle 13 may be a battery electric vehicle (BEV), a plug-in hybrid electric vehicle (PHEV), an extended-range electric vehicle (EREV), or any other vehicle embodiment having at least one electric-only/electric vehicle (EV) operating mode.

The system 10 includes a server 16 in communication with a client device 12 and the various charging stations 20. The client device 12 may be, for example, a vehicle or handheld navigation system, a smart phone, or a personal digital assistant (PDA). The client device 12 may have direct or indirect access to route-planning navigation software, or to software that merely displays the locations of known charging stations 20 on a map. A display screen 32 is included with the client device 12 for presenting information relating to charging options, status, availability, etc., to a user of the client device 12 as described below.

When the client device 12 is configured as a navigation system of any type, the driver of the vehicle 13 can view the available charging stations 20 as points of interest on a displayed map, and can select, e.g., via a touch screen of the client device 12 when the display screen 32 is so configured, the particular charging station 20 that the driver wishes to reserve. Because driving route information can be displayed by such a client device 12, a driver of the vehicle 13 can readily select a charging station 20 that is within a particular range of a desired trip destination.

The client device 12 is in communication with the server 16 over a network connection 14, e.g., a wireless, broadband, internet, or other suitable network connection. The server 16 is likewise in communication with the various charging stations 20 over a similar network connection 18. The server 16 is programmed with or otherwise informed of the availability of each of the charging stations 20, and is configured to accurately schedule blocks of charging time in response to this type of information.

For instance, the server 16 may maintain a calendar 24 and a database 26. The calendar 24 may be configured to record user information such as driver's name, address, vehicle make, model, license plate number, and/or identification number, and/or any other unique identifier, and to reserve a sufficient block of time for charging the vehicle 13.

Determination of the required amount of charging time can be arbitrary, or it may be a determination informed in part by the expected state of charge of the battery 15 upon reaching a designated charging station 20. For example, the present state of charge of the battery 15 may be determined, e.g., via a controller 25, and the distance/route to the desired destination may be used to determine the expected remaining state of charge. This information may be communicated to the server 16 via a telematics unit 30 or other means in order to facilitate accurate determination of an estimated required charging time.

Information may be recorded in the database 26 describing possible battery types, nominal charging times, charging capacity or electrical rating of the various charging stations 20, vehicle charging history, etc., whether for various vehicle models that might use a charging station 20 generally, and/or for specifically identified vehicles. External information, e.g., a temperature value external to the vehicle 13 such as ambient temperature, solar load acting on the vehicle 13, ambient humidity, etc., could be determined and factored into any of these calculations. Internal information, e.g., a temperature value internal to the vehicle 13 such as battery temperature and/or coolant temperature may be used to further optimize such calculations. This additional information may be accessed by the server 16 to accurately schedule a block of charging time.

The server 16 includes memory 28 which is tangible/non-transitory. The memory 28 may be any recordable medium that participates in providing computer-readable data or process instructions. Such a medium may take many forms, including but not limited to non-volatile media and volatile media. Non-volatile media may include, for example, optical or magnetic disks and other persistent memory. Volatile media may include, for example, dynamic random access memory (DRAM), which may constitute a main memory. Such instructions may be transmitted by one or more transmission media, including coaxial cables, copper wire and fiber optics, including the wires that comprise a system bus coupled to a processor of a computer. Memory 28 may also include a floppy disk, a flexible disk, hard disk, magnetic tape, any other magnetic medium, a CD-ROM, DVD, any other optical medium, etc.

The client device 12 and the server 16 can be configured or equipped with other required computer hardware, such as a high-speed clock, requisite Analog-to-Digital (A/D) and/or Digital-to-Analog (D/A) circuitry, any necessary input/output circuitry and devices (I/O), as well as appropriate signal conditioning and/or buffer circuitry. Any algorithms required by the server 16 or accessible thereby may be stored in memory 28 and automatically executed to provide the required functionality.

Still referring to FIG. 1, once a driver of the vehicle 13 has reserved a designated charging station 20 via the client device 12, the server 16 may generate an electronic token 22 as a unique identifier or key. The server 16 may then transmit the token 22 to the client device 12, where the token 22 may be recorded. The token 22 may also be recorded in another memory location aboard the vehicle 13, e.g., in the controller 25, and to confirm the reservation when the vehicle 13 reaches the charging station 20 that was previously reserved.

The information provided by the electronic token 22 may be scrambled, encrypted, or otherwise camouflaged for added security, or it may be randomly generated with a sufficient length and complexity such that the token 22 uniquely and securely identifies the vehicle 13 as being the correct vehicle 13 for the reserved charging station 20, and for the assigned block of charging time. The token 22 thereby helps prevent the unauthorized use of a given charging station 20. Additionally, because the token 22 already contains sufficient identifying information, the token 22 can be used to facilitate billing a driver or owner of the vehicle 13 for the use of the designated charging station 20.

Absent the present system 10, for instance in an alternative first-come, first-served approach, a driver of an EV may reach a charging station 20 with a low battery state of charge, only to find that the charging station 20 is already in use. This forces the driver to wait for the charging station 20 to become available. The delay could impact the driver's schedule for the day.

Referring to FIG. 2, the present method 100 is shown according to one possible embodiment. After initiating (*), the method 100 commences at step 102, wherein a driver of the vehicle 13 of FIG. 1 may enter a desired destination into the client device 12, e.g., a navigation system.

At step 104, the server 16 may determine whether one of the various charging stations 20 shown in FIG. 1 is present near a recorded desired destination. This information may be displayed to the driver via the client device 12, for instance as an icon on a displayed map or route trace. Optionally, the present and projected charging station availability may be transmitted or broadcast such that a status is displayed via the charging device 12, e.g., “charger available”, “charger in use”, etc. A driver could then select a charging station 20 with an available or projected available status.

At step 106, the driver can request a reservation for a designated one of the charging stations 20 identified at step 104 as being near the desired destination. If the driver makes such a request, the method 100 proceeds to step 106. The method 100 is otherwise finished.

At step 108, the server 16 contacts the designated charging station 20 identified at step 104 and determines its availability at an expected arrival time. In the possible embodiment of step 104 in which status information is pushed or broadcasted to the client device 12, such as via icons and/or availability status messages, step 108 may still be executed to verify the status. The expected arrival time could be automatically calculated by the client device 12 using a departure time entered or otherwise determined via the client device 12, or it could be selected by the driver. The method 100 then proceeds to step 110.

At step 110, the server 16 processes the information from the charging station 20 to determine whether the charging station 20 is available at the expected arrival time. If the designated charging station 20 is available, the method 100 proceeds to step 112. If not, the method 100 proceeds to step 113.

At step 112, the server 16 generates a reservation and issues the electronic token 22, which is transmitted to the vehicle 13, the controller 25, and/or the client device 12. For example, the server 16 may access the calendar 24 and the database 26, and may record a block of time which is sufficient for charging the vehicle 13 given its known charging characteristics. Step 112 may optionally entail determining the expected state of charge of the battery module 15 upon arriving at the charging station 20, and/or arbitrarily assigning time using information in the database 26. The method 100 then proceeds to step 114.

At step 113, the server 16 transmits a message to the client device 12 notifying the driver of the vehicle 13 that the designated charging station 20 is unavailable at the expected arrival time. The method 100 then proceeds to step 115.

At step 114, the server 16 locks and holds access to the designated charging station 20 that was reserved at step 112. Only the holder of the token 22 may access that particular charging station 20 at the assigned time, as noted above. Step 114 may optionally include displaying a message or a color coded signal to the driver, e.g., flashing red when the charge is not authorized or green when it is. Additional options include displaying remaining charging time, much like a parking meter displays a remaining park time. Some minimal grace period could be permitted at the end of charge to allow a driver sufficient time to disconnect from the charging station 20 and pull away.

At step 115, the driver may record a different departure time. If the driver does so, the method 100 proceeds to step 117. Otherwise, the method 100 is finished.

At step 116, the vehicle 13 commences charging at the reserved charging station 20. Optionally, the server 16 may be configured to reopen the reservation if the vehicle 13 does not commence charging within a permissible window of time before or after the reserved time. This may further optimize utilization by ensuring that no-shows do not prevent use of the reserved charging station 20. Likewise, if a driver discontinues charging well before the allotted time is up, the server 16 may re-open the reservation for the remaining portion of the reserved time. The method 100 is finished (**) upon completion of step 116.

At step 117, the driver is informed, via the client device 12, of a set of feasible departure times or, alternatively, of charging start times. Again, departure times may be used by the client device 12 in conjunction with its existing navigation capabilities to calculate an arrival time, which can then be used as the start time for charging. Once the feasible times are displayed to the driver via the client device 12, the method 100 proceeds to step 119.

At step 119, if the driver selects one of the feasible times displayed at step 117, the method 100 proceeds to step 112. Otherwise, the method 100 is finished (**).

While the best modes for carrying out the invention have been described in detail, those familiar with the art to which this invention relates will recognize various alternative designs and embodiments for practicing the invention within the scope of the appended claims.

1. A method for reserving an electric charging station for a vehicle having a controller and a battery, the method comprising:
receiving, by a server, a desired destination from a client device;
verifying the availability of a designated charging station at an expected arrival time of the vehicle at the desired destination;
reserving, via the server, the designated charging station when the designated charging station is available at the expected arrival time;
receiving information from the controller using the server, including a state of charge and a temperature of the battery;
generating an electronic token via the server, wherein the token uniquely identifies the vehicle; and
transmitting the electronic token from the server to the client device, wherein the token confirms the reservation and prevents unauthorized use of the designated charging station by another vehicle.

2. The method of claim 1, wherein the client device is a navigation system, the method further comprising:
recording the desired destination using the navigation system; and
using the navigation system to calculate the expected arrival time at the designated charging station.

3. The method of claim 1, wherein the server includes a calendar and a database of information describing the known charging characteristics of the vehicle, and wherein reserving the designated station includes scheduling a block of charging time using the calendar in a length which corresponds to the known charging characteristics.

4. The method of claim 3, further comprising:
modifying the known charging characteristics using a temperature value internal to the vehicle in addition to the battery temperature and a temperature value external to the vehicle.

5. The method of claim 1, further comprising:
communicating, via the controller, an expected remaining state of charge of the battery of the vehicle to the server; and
reserving the designated charging station by scheduling a block of charging time corresponding to the expected remaining state of charge.

6. The method of claim 1, further comprising:
using the token to bill an owner of the vehicle for use of the designated charging station.

7. (canceled)

8. The method of claim 1, further comprising:
displaying, via the client device, a list of feasible departure times for an alternate reservation of the designated charging station when the designated charging station is not available at the expected arrival time.

9. A system for reserving an electric charging station for a vehicle, the system comprising:
a server in communication with a client device and with a plurality of different charging stations;
a tangible, non-transitory memory device; and
instructions recorded on the memory device which are executable by the server;
wherein the server is configured to execute the instructions, and wherein execution of the instructions by the server causes the server to:
receive a desired destination from the client device;
receive information from a controller of the vehicle, including a state of charge and a temperature of the battery;
generate an electronic token that uniquely identifies the vehicle;
verify the availability of a designated charging station of the plurality of different charging stations at an expected arrival time of the vehicle at the desired destination;
reserve the designated charging station when the designated charging station is available at the expected arrival time; and
transmit the electronic token to the client device to thereby confirm the reservation and prevent unauthorized use of the designated charging station by another vehicle.

10. The system of claim 9, wherein the server includes a calendar and a database of information describing the known charging characteristics of the vehicle, and wherein the server is configured to schedule a block of charging time via the calendar using the known charging characteristics of the vehicle.

11. The system of claim 9, wherein the system is further configured to:
receive, from the controller of the vehicle, an expected remaining state of charge of a battery of the vehicle; and
reserve, via the server, the designated station by scheduling a block of charging time corresponding to the expected remaining state of charge.

12. The system of claim 9, wherein the server is configured to lock or prevent use of the designated charging station by any vehicle not specifically identified by the electronic token.

13. The system of claim 12, wherein the server is further configured to transmit at least one of a status message and a status icon to the designated charging station.

14. The system of claim 9, wherein the server is configured to display, via the client device, a list of feasible departure times for an alternate reservation of the designated charging station when the designated charging station is not available at the expected arrival time.

15. A method for reserving one of a plurality of electric charging stations for a vehicle having a battery and a controller, comprising:
receiving, via a server, a desired destination and an expected arrival time at the desired destination from a navigation system;
receiving information from the controller using the server, including a state of charge and a temperature of the battery;
using the server to verify the presence of a designated one of the plurality of electric charging stations that is within a calibrated range of the desired destination;
determining the availability of the designated station at the expected arrival time;
reserving the designated station at the expected arrival time when the designated station is available, including:
scheduling a block of time having a length which corresponds to a state of charge of a battery of the vehicle; and
locking or preventing use of the designated station by any vehicle not specifically identified in an electronic token, wherein the electronic token confirms the reservation and uniquely identifies the vehicle;
generating the electronic token using the server;
transmitting the electronic token from the server to the navigation system; and
preventing use of the designated charging station by any vehicle not identified in the electronic token.

16. The method of claim 15, wherein the server includes a calendar and a database of information describing the known charging characteristics of the vehicle, and wherein reserving the designated station includes scheduling a block of charging time via the calendar using the known charging characteristics of the vehicle.

17. The method of claim 15, further comprising:
identifying an owner of the vehicle using the electronic token; and
billing the owner for use of the designated station.

18. The method of claim 15, further comprising:
displaying, via a display screen of the navigation system, a list of feasible departure times for an alternate reservation of the designated station.
